(19) United States
(12) Patent Application Publication
(10) Pub. No.: US 2009/0101634 A1
(43) Pub. Date: Apr. 23, 2009

(54) Joining Method

(75) Inventor: Reinhold Meier, Dorfen (DE)

Correspondence Address: Davidson, Davidson & Kappel, LLC, 485 7th Avenue, 14th Floor, New York, NY, 10018, US

(73) Assignee: MTU Aero Engines GmbH, Muenchen (DE)

(21) Appl. No.: 12/224,256

(22) PCT Filed: Feb. 16, 2007
(86) PCT No.: PCT/DE2007/000305

§ 371 Date: Oct. 30, 2008

(30) Foreign Application Priority Data
Feb. 23, 2006 (DE) 10 2006 008 440.3

(51) Int. Cl. B23K 13/01

(52) U.S. Cl. 219/617

(57) ABSTRACT

A joining method, in particular for gas turbine components, is provided wherein applying inductive heating, using at least one inductor, to a joining zone of a first component section and a second component section; following and/or during the step of applying inductive heating, exerting a press force on the first component second and the second component section to weld the first and second component section together, additionally heating by a capacitor discharge of the joining zone of the first and second component sections.

The present invention relates to a joining method, in particular for gas turbine components, according to the definition of the species set forth in claim 1.

Welding is known from the related art as a joining method for joining component sections, in the case of welding, the fundamental distinction being made among fusion welding methods, pressure welding methods, cold pressure welding methods and diffusion welding methods. The present invention is directed to a pressure welding method, in the case of pressure welding, a joining zone of component sections to be joined together being heated, and the component sections being joined by the application of a press force, respectively pressure, following and/or during the heating of the joining zone.

To join component sections of a gas turbine component, what is generally referred to as inductive, high-frequency pressure welding has proven effective as a pressure welding method. Thus, the European Patent Specification EP 1 112 141 B1 describes an inductive high-frequency pressure welding method, which provides for inductively heating butt joints between component sections to be joined together with the aid of at least one inductor. The welding method described in the European Patent Specification EP 1 112 141 B1 is primarily suited for joining component sections of thermally non-dissipative materials, such as of titanium-based materials, since, in this case, the heat introduced by induction into the butt joints, respectively joining zone, remains in the region of the butt joints, respectively joining zone. If, on the other hand, the intention is to join component sections made of thermally dissipative materials, such as nickel-based materials or cobalt-based materials, for example, using the method described in the European Patent Specification EP 1 112 141 B1, then the problem arises that the heat introduced by induction is quickly or readily dissipated out of the region of the butt joints, respectively joining zone, so that, in the final analysis, the temperature of the joining zone, respectively butt joints, is too low, thereby ultimately degrading the quality of the welded joint.

Against this background, an object of the present invention is to devise a novel joining method. This objective is achieved by a joining method as set forth in claim 1. In accordance with the present invention, the joining zone of the two component sections is heated by induction using at least one inductor, and, in addition, by a capacitor discharge.

Along the lines of the present invention, the component sections to be welded together are heated in the region of their butt joints, respectively joining zone, on the one hand, by induction and, on the other hand, by a capacitor discharge. This makes it possible to ensure a temperature that suffices for producing a high-quality welded joint in the region of the butt joints, respectively joining zone, even when working with component sections of thermally dissipative materials.

Preferred embodiments of the present invention are derived from the dependent claims and from the following description. Exemplary embodiments of the present invention are explained in greater detail in the following.

The present invention relates to a method for joining, namely for welding together, component sections of a component, in particular of a gas turbine component.

Along the lines of the present invention, the component sections are essentially welded together in accordance with the inductive, high-frequency pressure welding principle; in the case of inductive, high-frequency pressure welding, the component sections to be joined being inductively heated in the region of the butt joints, respectively joining zone, using at least one inductor, and, following and/or during the inductive heating, a press force being exerted on the component sections, namely on the butt joints, respectively joining zone, to weld together the same.

In accordance with the present invention, a capacitor-discharge resistance pressure welding is superposed on the inductive, high-frequency pressure welding and, in fact, in such a way that, besides being heated inductively, the joining zone of the two components is heated by a capacitor discharge.

The heating of the joining zone, respectively of the butt joints of the component sections to be joined together, by the capacitor discharge preferably takes place immediately before the press force is exerted on the component sections, the heating by capacitor discharge being carried out in a pulsed operation for a duration of between 0.1 milliseconds and 20 milliseconds, preferably for a duration of approximately 10 milliseconds. In the case of the capacitor discharge, electrical energy stored in a capacitor is directed through the joining zone, which has a relatively high electrical resistance, in order to heat the same.

The method according to the present invention is preferably used for welding together component sections made of thermally dissipative materials. The method is used, in particular, for welding together component sections made of nickel-based materials, respectively nickel-based alloys or cobalt-based materials, respectively cobalt-based alloys. The method according to the present invention makes it possible, even when working with component sections of thermally dissipative materials, to provide a high enough temperature in the region of the butt joints, respectively joining zone, in order to realize a welded joint of good quality.

1-5. (canceled)

6. A method for joining a first component section to a second component section comprising:
applying inductive heating, using at least one inductor, to a joining zone of a first component section and a second component section;
following and/or during the step of applying inductive heating, exerting a press force on the first component second and the second component section to weld the first and second component section together; and
additionally heating, by a capacitor discharge, the joining zone of the first and second component sections.

7. The joining method as recited in claim 6, wherein the component sections are gas turbine components.

8. The joining method as recited in claim 6, wherein the step of heating by a capacitor discharge is superposed on the step of applying inductive heating.

9. The joining method as recited in claim 6, wherein the step of heating by the capacitor discharge of the joining zone takes place immediately before the step of exerting a press force on the first component second and the second component section.

10. The joining method as recited in claim 6, wherein the step of heating by the capacitor discharge of the joining zone is carried out in a pulsed operation for a duration of between 0.1 milliseconds and 20 milliseconds.

11. The joining method as recited in claim 6, wherein the first component section and the second component section are made of thermally dissipative materials.

12. The joining method as recited in claim 10, wherein the first component section and the second component section are made of nickel-based materials or of cobalt-based materials.
